(19) United States
(12) Patent Application Publication
(10) Pub. No.: US 2004/0056547 A1
(43) Pub. Date: Mar. 25, 2004

(54) Hydrodynamic bearing system

(75) Inventors: Andreas Kull, Donaueschingen (DE); Roland Beckers, Lauffen (DE)

Correspondence Address: SCHULTE ROTH & ZABEL LLP, ATTN: JOEL E. LUTZKER, 919 THIRD AVENUE, NEW YORK, NY, 10022, US

(73) Assignee: Minebea Co., Ltd., Meguro-ku (JP)

(21) Appl. No.: 10/423,769

(22) Filed: Apr. 25, 2003

(30) Foreign Application Priority Data
Aug. 29, 2002 (DE) 102 39 650.7

(51) Int. Cl. H02K 5/00

(52) U.S. Cl. 310/91

(57) ABSTRACT

A hydrodynamic bearing system, in particular for a spindle motor, preferably for driving magnetic disks in disk drives, having at least one journal bearing formed by a shaft rotatably borne in a bearing sleeve. The hydrodynamic bearing system further includes at least one thrust bearing formed by a thrust plate, rotatably received in a recess of the sleeve and securely joined to the shaft, and a counter-bearing associated with the thrust plate that is in the form of a cover plate. The cover plate rests on and is attached to one end face of the sleeve. This reduces assembly-induced flexure in the cover plate.

### CROSS REFERENCE TO RELATED APPLICATIONS

This application claims all rights of priority to German Patent Application Serial No. DE 102 39 650.7, filed Aug. 29, 2002 (pending).

### BACKGROUND

The invention relates to a hydrodynamic bearing system, in particular to hydrodynamic bearings utilized in spindle motors for disk drives.

Spindle motors comprise essentially a stator, a rotor, and at least one bearing system arranged therebetween. The electric motor-driven rotor is supported for rotation by the bearing system such that it is rotatable relative to the stator. Rolling bearings and hydrodynamic friction bearings can be used as the bearing system.

A hydrodynamic bearing system includes a bearing sleeve and a shaft that is arranged in an axial bore of the bearing sleeve. The shaft rotates freely in the bearing sleeve. Opposing surfaces of the sleeve and the shaft form a journal bearing. The bearing surfaces of the shaft and the sleeve, which are mutually mechanically linked, are separated from one another by a thin concentric bearing gap filled with a lubricant.

A pattern of grooves is provided on at least one of the bearing surfaces. Due to the relative rotational movement, the groove pattern generates pressure gradients resulting in acceleration forces acting on the lubricant located in the bearing gap. Thus, pumping effect is generated in the lubricant leading to the formation of a homogeneous and uniformly thick film of lubricant that is stabilized by zones of hydrodynamic pressure.

The cohesive capillary lubricant film and the self-centering mechanism of the hydrodynamic journal bearing ensure stable, concentric rotation between shaft and bushing.

Appropriately designed hydrodynamic thrust bearings prevent shaft displacement along the axis of rotation. In a hydrodynamic thrust bearing, the bearing surfaces that are mutually mechanically linked, are each arranged in the plane perpendicular to the axis of rotation and are axially separated from one another by a thin, preferably even bearing gap that is filled with lubricant. At least one of the thrust bearing surfaces is provided with a pattern of grooves, which generate axial pressure gradients during the rotation.

Since a single hydrodynamic thrust bearing typically can only take up forces in one direction, generally two hydrodynamic thrust bearings working in opposition to one another are provided.

The stiffness of hydrodynamic bearings is largely determined by the bearing gap thickness, the viscosity of the lubricant, and the shape and/or design of the pattern of grooves.

Hydrodynamic thrust bearings provided to take up the axial forces are preferably formed by two end faces of a thrust plate arranged at the end of the shaft, and a corresponding end face of the sleeve, positioned opposite to one end face of the thrust plate, and an inner end face of a cover plate, positioned opposite to the other end face of the thrust plate. The cover plate thus forms a counter-bearing to the thrust plate, seals the entire bearing system at the bottom of the sleeve and prevents air from penetrating into the bearing gap filled with lubricant.

The specific advantages of hydrodynamic friction bearings as opposed to rolling bearings are the higher running precision, the insensitivity to shock loads, and the smaller number of components. Since the sliding elements do not touch one another at nominal speed, they work with a low rate of wear and nearly soundlessly.

U.S. Pat. No. 6,183,135 B1 discloses a hydrodynamic bearing system described in the foregoing with a thrust plate arranged on one end of the shaft. The thrust plate is received in a first sleeve recess adapted to the dimensions of the thrust plate and is covered by a cover plate that is arranged in a second sleeve recess of greater diameter. The greater diameter of the second recess results in a step being formed inside the bearing sleeve that acts as an axial stop for the cover plate.

A welded connection generally holds the cover plate in the second recess. However, due to the production tolerances in terms of the interior diameter of the recess and the exterior diameter of the cover plate, the type of fit between the cover plate and the associated recess in the sleeve can vary greatly. If the exterior diameter of the cover plate is too great, the resulting interference causes an interference fit that can lead to undesired flexure in the cover plate after assembly. This results in different pressure distribution profiles on the two sides of the thrust plate. If the exterior diameter of the cover plate is too small, this can lead to problems when the two parts are welded.

### SUMMARY OF THE INVENTION

It is an object of the invention to develop a hydrodynamic bearing system such that flexure of the cover plate due to assembly deficiencies is substantially or entirely avoided.

In accordance with the invention, the bearing system has at least one journal bearing that encompasses a rotatably supported shaft in a bore of a sleeve. The bearing system further includes at least one thrust bearing having a thrust plate, which is rotatably received in a recess in the sleeve and securely joined to the shaft, and a counter-bearing associated with the thrust plate. The counter-bearing is preferably in the form of a cover plate, which rests against and is affixed to the end face of the sleeve.

In a preferred embodiment of the invention, the exterior diameter of the cover plate is essentially equal to the exterior diameter of the sleeve. This results in the sleeve being cleanly closed by the cover plate.

The cover plate is fixed in the provided position and welded at its exterior circumference to the exterior circumference of the sleeve.

The invention offers a plurality of advantages as compared with the prior art.

First, the tendency of the cover plate to flex in the center is substantially reduced since the cover plate rests largely stress-free on the end face of the sleeve.

Since there is no second recess for receiving the cover plate, the exterior diameter of the sleeve can be reduced by twice the wall thickness of the edge surrounding this second recess.

Due to the smaller exterior diameter of the sleeve, there is more room for the electromechanical motor components, so that the output volume rises. This means that either the motor output increases at exterior dimensions that are otherwise identical or that the exterior dimensions can be reduced while maintaining identical motor output. Additionally, manufacturing costs for the sleeve can be reduced because, firstly, less material is required, and, secondly, there are no processing costs for the second recess for receiving the cover plate.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1: is a schematic sectional view of a spindle motor with an inventive design of the bearing system;

FIG. 2: is a schematic sectional view of a spindle motor's bearing system in accordance with the prior art.

### DESCRIPTION OF A PREFERRED EMBODIMENT OF THE INVENTION

The exemplary embodiment illustrates a spindle motor for driving a disk drive with an inventive hydrodynamic bearing system. In the example illustrated, a shaft carrying a rotor is rotatably borne in a fixed bearing sleeve. Of course, the invention also encompasses designs in which a fixed shaft is enclosed by a rotatable bearing sleeve that carries the rotor.

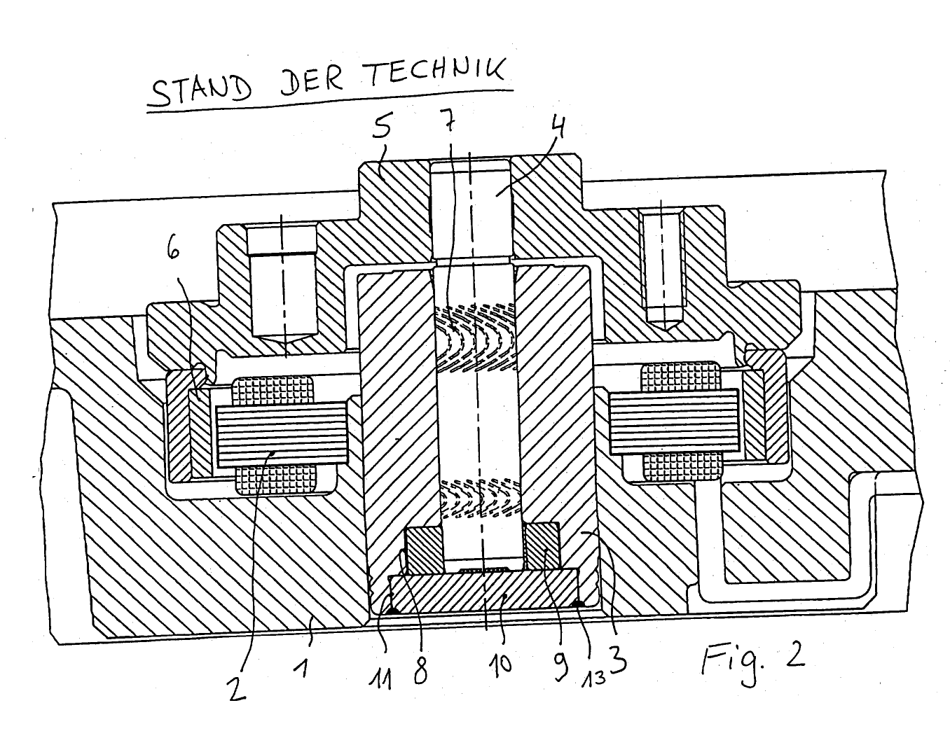

FIG. 2 illustrates a spindle motor in accordance with the prior art. The spindle motor encompasses a fixed base plate 1 having a stator assembly 2, including stator core and coils, arranged thereon. A bearing sleeve 3 is securely received in a recess in the base plate 1 and has an axial cylindrical bore in which a shaft 4 is rotatably received. The free end of the shaft 4 carries a rotor hub 5 on which one or more storage disks (not shown) of the disk drive are arranged and attached. Arranged at the interior of the lower edge of the rotor hub 5 is an annular permanent magnet 6 with a plurality of pole pairs. Magnetic poles are actuated with an alternating electrical field produced by the stator assembly 2, which is spaced from the rotor hub by a working air gap, such that the rotor hub 5 together with the shaft 4 is caused to rotate.

A bearing gap filled with a lubricant is formed between the interior diameter of the bearing sleeve 3 and the exterior diameter of the shaft 4. The hydrodynamic bearing system includes two journal bearing regions (not shown in detail) formed by a pattern of grooves 7 that is provided on the external surface of the shaft 4 and/or on the internal surface of the bearing sleeve 3. When the rotor hub 5 with the shaft 4 are caused to rotate, hydrodynamic pressure builds in the bearing gap, that is, in the lubricant situated therein, due to the pattern of grooves 7 such that the bearing becomes capable of supporting the rotating shaft.

The hydrodynamic bearing system further includes a hydrodynamic thrust bearing located at the lower end of the shaft 4. More particularly, the thrust bearing is formed by a thrust plate 9 mounted on the lower end of shaft 4 and a cover plate 10 enclosing the bearing sleeve. The thrust plate and the cover plate take on the axial forces of the bearing system. Cover plate 10 forms a counter-bearing to the thrust plate 9 and seals the entire bearing system at the bottom so that no lubricant can escape from the bearing gap.

In the previously known prior art, both the thrust plate 9 and the cover plate 19 are received in corresponding annular recesses 8 and 11 in the bearing sleeve 3. The sleeve 3 is provided at its lower end face with a first recess 8 for receiving the thrust plate 9. A second recess 11 with a larger diameter receives the cover plate 10.

A weld seam 13 joins the cover plate 10 and the surface of recess 11 in the bearing sleeve 3.

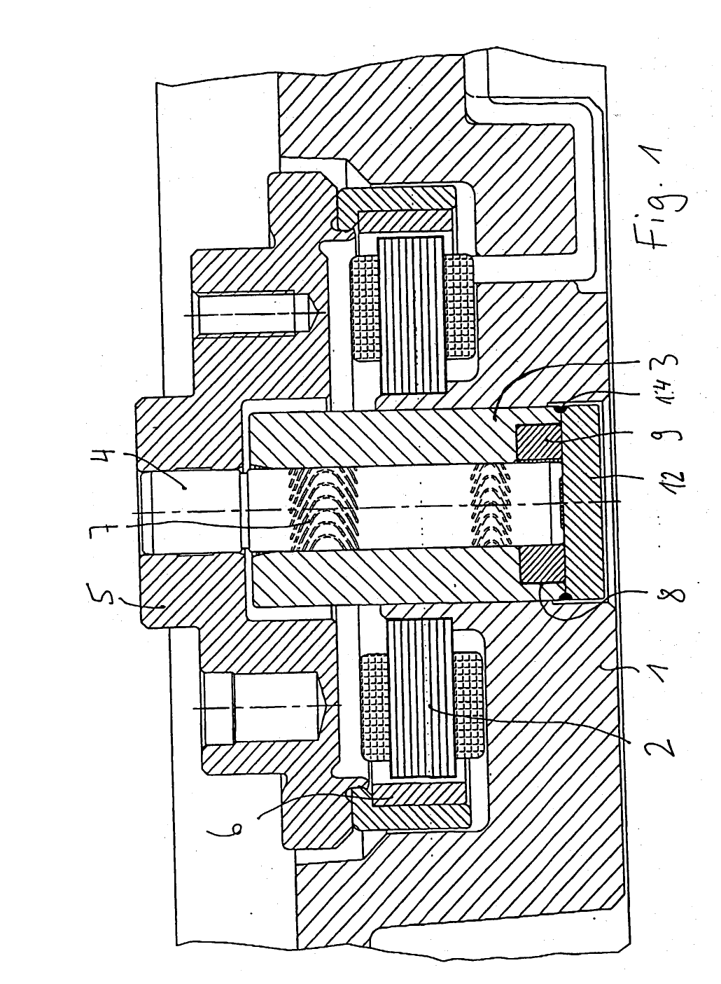

FIG. 1 illustrates an inventive design of a spindle motor.

In contrast to the spindle motor of FIG. 2, the bearing sleeve 3 has only one recess 8 that receives the thrust plate 9. A cover plate 12 is positioned outside the sleeve adjacently to the end face of bearing sleeve 3. The outer diameter of the cover plate 12 is the same as the exterior diameter of the bearing sleeve 3. A weld seam 14 joins the end face of bearing sleeve 3 and cover plate 12 together at their exterior circumferences.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

What is claimed is:

1. A hydrodynamic bearing system for a spindle motor, comprising:
a shaft;
a bearing sleeve;
at least one journal bearing formed between said shaft and said bearing sleeve;
a thrust plate fixedly mounted on said shaft;
a cover plate positioned in an opposing counter-bearing relationship with said thrust plate; and
at least one thrust bearing formed between said thrust plate and said cover plate,
wherein said cover plate rests against and is affixed to an end face of said bearing sleeve and
wherein an exterior diameter of said cover plate is essentially equal to an exterior diameter of said bearing sleeve.

2. The hydrodynamic bearing system in accordance with claim 1, wherein said cover plate and said bearing sleeve are joined to one another at their exterior circumferences by a weld seam.

3. A spindle motor having a hydrodynamic bearing system, said hydrodynamic bearing system comprising:
a shaft;
a bearing sleeve;
at least one journal bearing formed between said shaft and said bearing sleeve;
a thrust plate fixedly mounted on said shaft;
a cover plate positioned in an opposing counter-bearing relationship with said thrust plate; and
at least one thrust bearing formed between said thrust plate and said cover plate,
wherein said cover plate rests against and is affixed to an end face of said bearing sleeve and
wherein an exterior diameter of said cover plate is essentially equal to an exterior diameter of said bearing sleeve.

4. The spindle motor in accordance with claim 3, wherein said cover plate and said bearing sleeve are joined to one another at their exterior circumferences by a weld seam.
